(19) United States
(12) Patent Application Publication
(10) Pub. No.: US 2018/0065593 A1
(43) Pub. Date: Mar. 8, 2018

(54) RESTRAINT SYSTEM

(71) Applicant: Inteva Products, LLC, Troy, MI (US)

(72) Inventor: David Kovac, Warren, MI (US)

(21) Appl. No.: 15/692,983

(22) Filed: Aug. 31, 2017

Related U.S. Application Data
(60) Provisional application No. 62/382,960, filed on Sep. 2, 2016.

(51) Int. Cl. B60R 22/14; B60R 22/00; B60R 22/32; B60R 21/12

(52) U.S. Cl. CPC B60R 22/14; B60R 22/001; B60R 2022/003; B60R 21/12; B60R 22/325

(57) ABSTRACT

A restraint system for restraining a lower body portion of an individual within a seat including a rigid member configured to selectively restrain the lower body portion such that the lower body portion of the individual is movable only within a predefined area of movement. The rigid member is mounted to the seat and is capable of movement between a stowed position and a deployed position. The lower body portion is restrained by the rigid member when in the deployed position. A locking mechanism locks the rigid member in the stowed position and the deployed position. A release mechanism is associated with the locking mechanism. The release mechanism is located at a predetermined distance from the locking mechanism such that the release mechanism is located outside of the area of movement.

### CROSS-REFERENCE TO RELATED APPLICATION

This application claims the benefit of 62/382,960, filed Sep. 2, 2016, which is incorporated herein by reference in its entirety.

### BACKGROUND

Exemplary embodiments of the present invention relate to restraint systems for use with vehicles.

Current police vehicles use standard seat belt systems to secure detainees in the back of the police vehicle. Referring to FIG. 1, the current approach for restraining handcuffed detainees is through the use of a seat belt 12 constructed out of a flexible material with a buckle. These devices permit relative movement between the occupant and the belt, except in a collision wherein a tensioner cinches the belt and inhibits excessive movement. In a police vehicle the objective is to maximize restraint, where necessary, and to provide for a safe environment for the officer as well as the detainee, and other persons within close proximity to the vehicle.

Accordingly, it is desirable to provide a restraint system for a vehicle that addresses the aforementioned needs.

### SUMMARY

In accordance with an embodiment of the present invention a restraint system for restraining a lower body portion of an individual within a seat including a rigid member configured to selectively restrain the lower body portion such that the lower body portion of the individual is movable only within a predefined area of movement. The rigid member is mounted to the seat and is capable of movement between a stowed position and a deployed position. The lower body portion is restrained by the rigid member when in the deployed position. A locking mechanism locks the rigid member in the stowed position and the deployed position. A release mechanism is associated with the locking mechanism. The release mechanism is located at a predetermined distance from the locking mechanism such that the release mechanism is located outside of the area of movement.

In addition to one or more of the features described above, or as an alternative, in further embodiments the restraint system includes a mounting bracket for attaching to a mounting surface near the area of movement of the individual.

In addition to one or more of the features described above, or as an alternative, in further embodiments the mounting surface is associated with a seat disposed within a vehicle.

In addition to one or more of the features described above, or as an alternative, in further embodiments the seat of the vehicle includes a cavity for receiving the restraint system such that when the rigid member is in the stowed position the restraint system is located substantially within the cavity.

In addition to one or more of the features described above, or as an alternative, in further embodiments the cavity is located underneath the seat.

In addition to one or more of the features described above, or as an alternative, in further embodiments the mounting surface is positioned in front of the lower body portion of the individual.

In addition to one or more of the features described above, or as an alternative, in further embodiments the stowed position and the deployed position are coplanar.

In addition to one or more of the features described above, or as an alternative, in further embodiments the rigid member includes a “U” shaped portion configured to surround a portion of a pair of legs of the individual.

In addition to one or more of the features described above, or as an alternative, in further embodiments the release mechanism includes a cable system and a housing with a spring biased release paddle, wherein the cable system includes at least one cable that is secured to the spring biased release paddle at one end and the locking mechanism at the other end.

In addition to one or more of the features described above, or as an alternative, in further embodiments the locking mechanism includes a mech lock having a movable inner rod coupled to the rigid member.

In addition to one or more of the features described above, or as an alternative, in further embodiments the locking mechanism includes a mech lock for maintaining the rigid member in the deployed position.

In addition to one or more of the features described above, or as an alternative, in further embodiments the release mechanism includes an actuator and a coupling mechanism secured at a first end to the actuator and at a second end to the mech lock.

In addition to one or more of the features described above, or as an alternative, in further embodiments the actuator is located within a handle connected to the rigid member.

In addition to one or more of the features described above, or as an alternative, in further embodiments the coupling mechanism is a cable.

In addition to one or more of the features described above, or as an alternative, in further embodiments the mech lock includes an inner slide and an outer rod, the inner rod being selectively coupled to the outer rod, wherein the release mechanism decouples the inner rod from the outer rod to allow movement of the rigid member.

In addition to one or more of the features described above, or as an alternative, in further embodiments comprising: a second rigid member for selectively restraining an upper body portion such that the upper body portion of the individual is movable only within a second predefined area of movement, the second rigid member being movable between a stowed position and a deployed position, the upper body portion being restrained by the second rigid member only in the deployed position; a second locking mechanism for locking the second rigid member in the deployed position; and a second release mechanism associated with the second locking mechanism, the second release mechanism being located at a predetermined distance from the second locking mechanism such that the second release mechanism is located outside of a second area of movement within the range of movement.

In addition to one or more of the features described above, or as an alternative, in further embodiments a spit shield assembly is associated with the second rigid member, the spit shield assembly being movable between a stowed position and a deployed position, wherein in the deployed position, the spit shield assembly substantially blocks a fluid discharged from the individual.

In accordance with an embodiment of the present invention a personal restraint module includes a seat structure defining at least one seat and a first restraint system integrated with the seat structure adjacent the at least one seat to selectively restrain a body portion of an individual seated within the at least one seat. The first restraint system is movable between a stowed position and a deployed position. The body portion is only restrained when the first restraint system is in the deployed position.

In addition to one or more of the features described above, or as an alternative, in further embodiments the first restraint system is locked in the deployed position.

In addition to one or more of the features described above, or as an alternative, in further embodiments a first release mechanism is associated with the first restraint system, the first release mechanism being operable to release the first restraint system from the deployed position.

In addition to one or more of the features described above, or as an alternative, in further embodiments the first release mechanism is integrated into a portion of the seat structure.

In addition to one or more of the features described above, or as an alternative, in further embodiments comprising: a second restraint system integrated with the seat structure adjacent the at least one seat to selectively restrain another body portion of the individual, the second restraint system being movable between a stowed position and a deployed position, wherein the another body portion is only restrained when the second restraint system is in the deployed position.

In addition to one or more of the features described above, or as an alternative, in further embodiments the second restraint system is locked in the deployed position.

In addition to one or more of the features described above, or as an alternative, in further embodiments a second release mechanism is associated with the second restraint system, the second release mechanism being operable to release the second restraint system from the deployed position.

In addition to one or more of the features described above, or as an alternative, in further embodiments at least one of the first restraint system and the second restraint system is configured to restrain an upper body portion of the individual and the other of the first restraint system and the second restraint system is configured to restrain the lower body portion of the individual.

In addition to one or more of the features described above, or as an alternative, in further embodiments the seat structure includes at least one molded component positioned adjacent to a support structure.

In addition to one or more of the features described above, or as an alternative, in further embodiments the support structure includes a base frame and a main cage.

In addition to one or more of the features described above, or as an alternative, in further embodiments the personal restraint module is adapted for use in a building.

In addition to one or more of the features described above, or as an alternative, in further embodiments the personal restraint module is adapted for use in a vehicle.

In addition to one or more of the features described above, or as an alternative, in further embodiments the personal restraint module is configured as at least a portion of a back seat of a vehicle.

In addition to one or more of the features described above, or as an alternative, in further embodiments the seat structure defines a cavity within which one or more components may be located.

In addition to one or more of the features described above, or as an alternative, in further embodiments a removable access panel selectively provides a user access to the cavity.

In addition to one or more of the features described above, or as an alternative, in further embodiments comprising a panel adapted for receiving one or more storage modules positioned within the cavity.

In addition to one or more of the features described above, or as an alternative, in further embodiments.

In accordance with another embodiment, a personal restraint module for restraining an individual includes a seat structure defining at least one seat and a restraint system integrated with the seat structure adjacent the at least one seat to selectively restrain a body portion of an individual. A contour of the seat structure prevents the individual from gaining leverage while seated.

In addition to one or more of the features described above, or as an alternative, in further embodiments the individual has a seated center of mass and the contour of the seat structure restricts the individual from positioning a foot generally underneath the seated center of mass.

In addition to one or more of the features described above, or as an alternative, in further embodiments once the individual is seated within the seat structure, the contour of the seat structure restricts the individual from standing to get out of the seat.

Additional features and advantages of the various aspects of exemplary embodiments of the present invention will become more readily apparent from the following detailed description in conjunction with the drawings wherein like reference numerals refer to corresponding parts in the several views.

### BRIEF DESCRIPTION OF THE DRAWINGS

FIG. 1 is a perspective view of a vehicle including a prior art seatbelt.

FIG. 2 is a side view of a vehicle including a personal restraint system according to an embodiment;

FIG. 3 is a front view of a torso restraint system in a vehicle, where the torso restraint system is in a stowed position according to an embodiment;

FIG. 4 is a side view of the torso restraint system shown in FIG. 3 in a deployed position according to an embodiment;

FIG. 5 is a perspective view of a torso restraint system having a spit shield in an stowed position and another torso restraint system having a spit shield in a deployed position according to an embodiment;

FIG. 6A is an exploded view of the torso restraint system shown in FIG. 2 according to an embodiment;

FIG. 6B is a perspective view of the torso restraint system shown in FIG. 2 according to an embodiment;

FIG. 7A is an enlarged cross-sectional view of a portion of the torso restraint system shown in FIG. 2 in the deployed position according to an embodiment;

FIG. 7B is an enlarged cross-sectional view of a portion of the torso restraint system shown in FIG. 2 in the stowed position according to an embodiment;

FIG. 8A is a perspective view of a release mechanism for activating the torso restraint system shown in FIG. 2 according to an embodiment;

FIG. 8B is a cross-sectional view of the release mechanism shown in FIG. 8A according to an embodiment;

FIGS. 9A and 9B are perspective views of the rigid member of the torso restraint system according to another embodiment according to an embodiment;

FIG. 10 is a side view of a leg restraint system in a vehicle, where the leg restraint system is in a stowed position according to an embodiment;

FIG. 11 is a side view of the leg restraint system shown in FIG. 10 in a deployed position according to an embodiment;

FIG. 12A is an exploded view of the leg restraint system shown in FIG. 10 according to an embodiment;

FIG. 12B is a perspective view of the leg restraint system shown in FIG. 10 according to an embodiment;

FIG. 13A is an enlarged view of a portion of the leg restraint system shown in FIG. 10 in the stowed position;

FIG. 13B is an enlarged view of a portion of the leg restraint system shown in FIG. 10 in the deployed position;

FIG. 14 is a perspective view of another leg restraint system in a stowed position according to an embodiment;

FIG. 15 is a perspective view of the leg restraint system of FIG. 14 in a deployed position according to an embodiment;

FIG. 16 is a perspective view of the leg restraint system of FIG. 14 according to an embodiment;

FIG. 17 is an illustration of yet another leg restraint system in a stowed position according to an embodiment;

FIG. 18 is an illustration of the leg restraint system of FIG. 17 in a deployed position according to an embodiment;

FIG. 19 is a perspective view of the leg restraint system of FIG. 17 according to an embodiment;

FIGS. 20A and 20B are various views of a release mechanism associated with the leg restraint system according to an embodiment;

FIG. 21 is a perspective view of a personal restraint module according to an embodiment;

FIG. 22 is another perspective view of a personal restraint module according to an embodiment;

FIGS. 23A-23C are perspective views of the various components of the personal restraint module according to an embodiment;

FIG. 24 is a side view of a personal restraint module according to an embodiment;

FIG. 25 is a perspective view of a back side of the personal restraint module according to an embodiment; and

FIG. 26 is a perspective view of a cavity defined within the personal restraint module according to an embodiment.

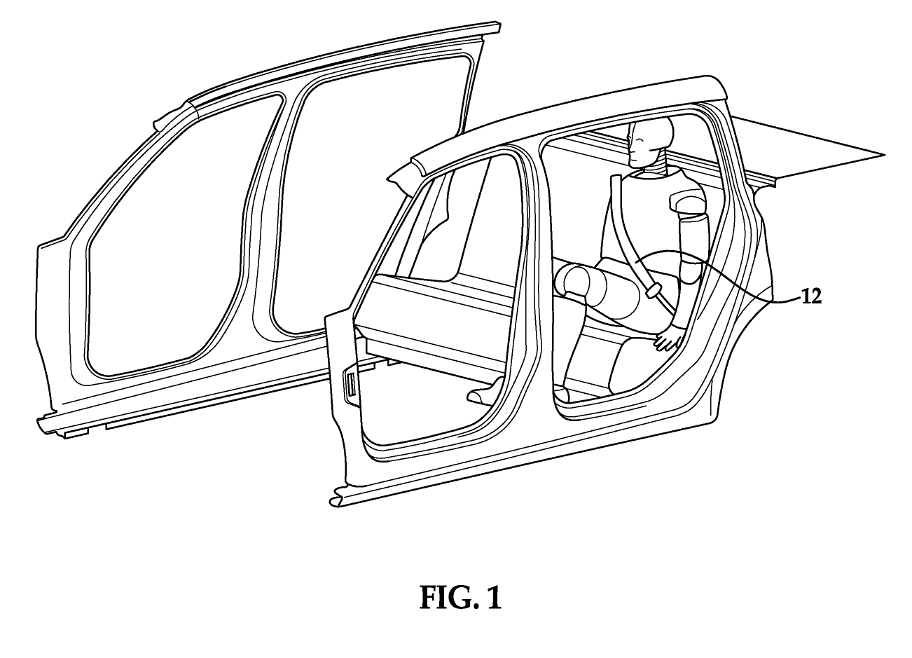

Although the drawings represent varied embodiments and features of the present invention, the drawings are not necessarily to scale and certain features may be exaggerated in order to illustrate and explain exemplary embodiments the present invention. The exemplification set forth herein illustrates several aspects of the invention, in one form, and such exemplification is not to be construed as limiting the scope of the invention in any manner.

### DETAILED DESCRIPTION

Various embodiments of the present invention relate to a restraint system for detaining an individual and in particular some embodiments are directed to a restraint system for law enforcement or military vehicles.

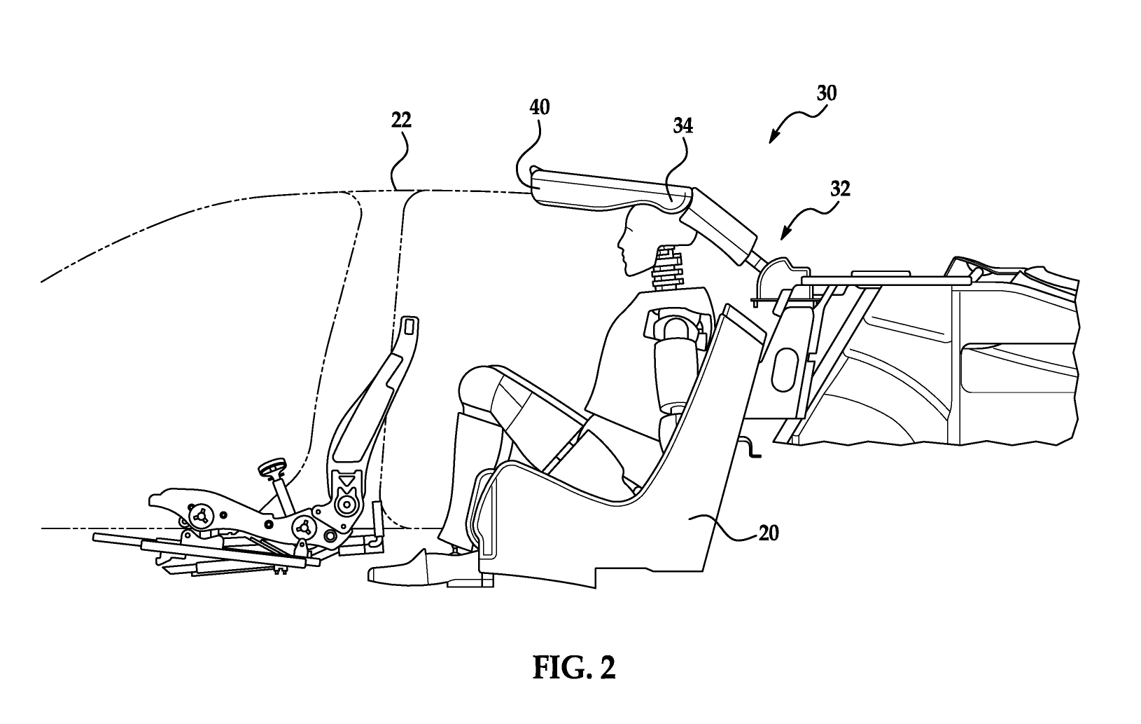

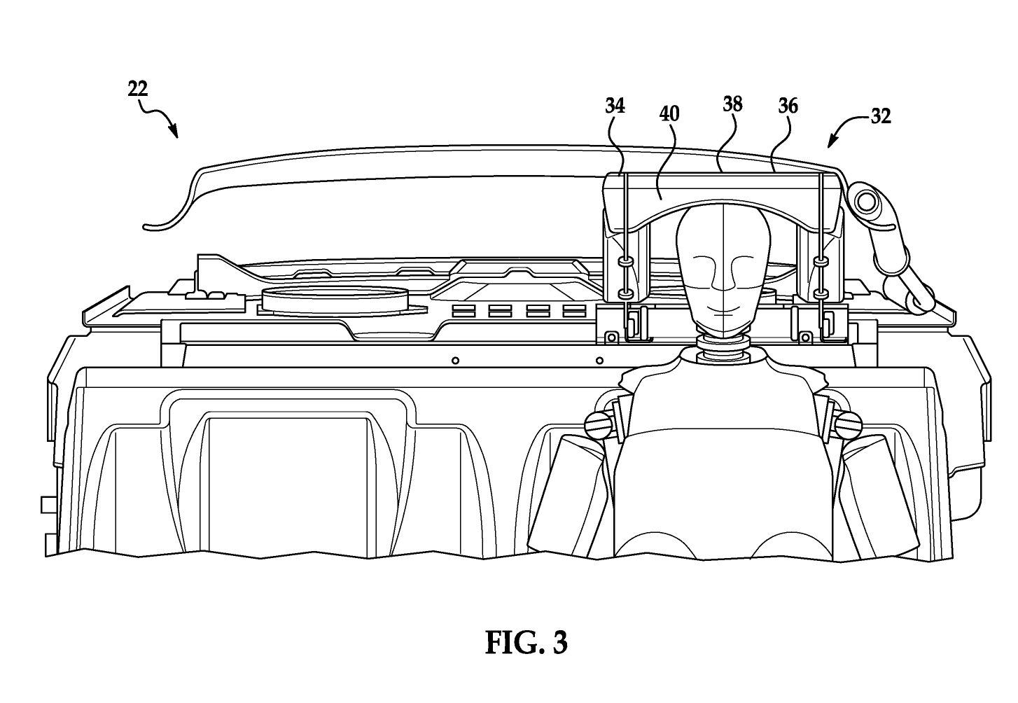

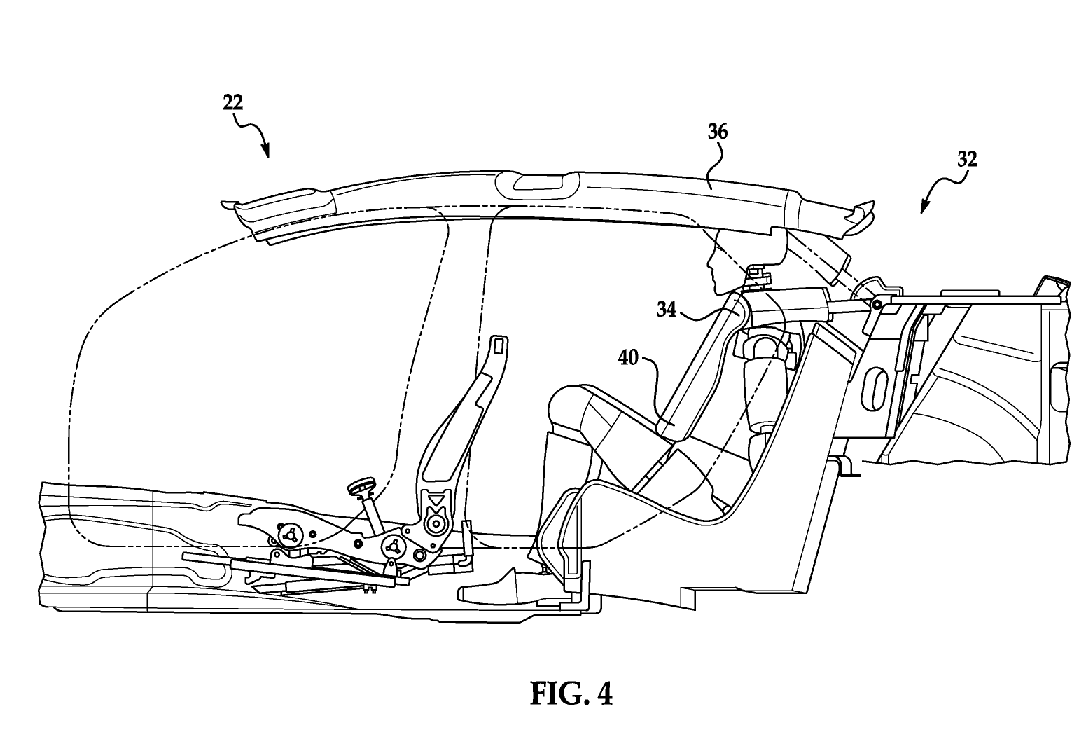

Referring now to the FIGS., a seat 20 including a person restraint system (PRS) 30 in accordance with a non-limiting embodiment of the disclosure is illustrated. In the illustrated, non-limiting embodiment, the PRS 30 is configured for use in a passenger vehicle environment 22, such as a police vehicle for example. However, it should be understood that the PRS 30 can be adapted for use in any environment where one or more individuals need to be detained. The PRS 30 is capable of moving between a stowed or inactive position and a deployed or active position. In an embodiment, illustrated in FIGS. 2-6, the PRS 30 includes a torso restraint system (TRS) 32. The torso restraint system 32 selectively restrains an upper body portion of an individual located in the vehicle 22 when it is in the active or deployed position. FIGS. 2 and 3 are illustrations of the torso restraint system 32 in the stowed position, and FIG. 4 is an illustration of the torso restraint system 32 in the deployed position.

The torso restraint system 32 includes a movable rigid member 34 configured to selectively contact and restrain the upper body of the individual. When the torso restraint system 32 is in the stowed position, the rigid member 34 does not generally restrain the upper body of an individual. Instead, the rigid member 34 is positioned above the seat 20 and does not generally make contact with the individual allowing the individual to get in and out of the seat 20.

In embodiments where the torso restraint system 32 is integrated into a vehicle 22, as shown in FIGS. 3-5, the rigid member 34 is sized to fit within an interior cabin of the vehicle 22. In an embodiment, the rigid member 34 and a head liner 36 of the vehicle 22 are configured such that most of the rigid member 34 is received within a recessed area 38 of the vehicle 22 when in the stowed position (see FIG. 3). A front portion 40 of the rigid member 34 is positioned to be generally parallel and does not interfere with the headliner 36 of the vehicle 22 when the rigid member 34 is received within the area 38. In one embodiment, the area 38 is recessed within the upper portion of the vehicle 22. Further, when the rigid member 34 is in the stowed position, the rigid member 34 does not interfere with the packaging and performance of the side airbag systems of the vehicle.

Turning now to FIG. 3, the rigid member 34 of the torso restraint system 32 generally restrains the upper body portion of the individual when in the active position. Thus, when in the active position the torso restraint system 32 provides for enhanced securing of the individual by restricting motion of the upper body of the individual.

In one non-limiting configuration, the rigid member 34 is generally “U” shaped to surround an upper portion of an occupant. In one embodiment, the rigid member 34 comprises a bent tubing constructed of a metal based material such as, for example, steel. One or more layers of padding 42 may be arranged about the front portion 40 of the rigid member 34 for engagement with an individual's chest. An upper torso plate 44 may be mounted opposite the padding 42 about the front portion 40 to couple the padding 42 to the rigid member 34. Alternatively, or in addition, one or more pads 46 may be mounted about the rigid member 34 at a location adjacent an individual's shoulders. The padding 44, 46 disclosed herein may be formed from any flexible, elastic, or pliable material, such as, for example, an open cell or closed cell foam. Depending on the application, such as the type of vehicle 22 in which the TRS is being used, i.e. sedan vs. sport utility vehicle, the contour of the rigid member 34, and the padding 42, 44, 46 attached thereto may vary to fit within the interior cabin of the vehicle 22.

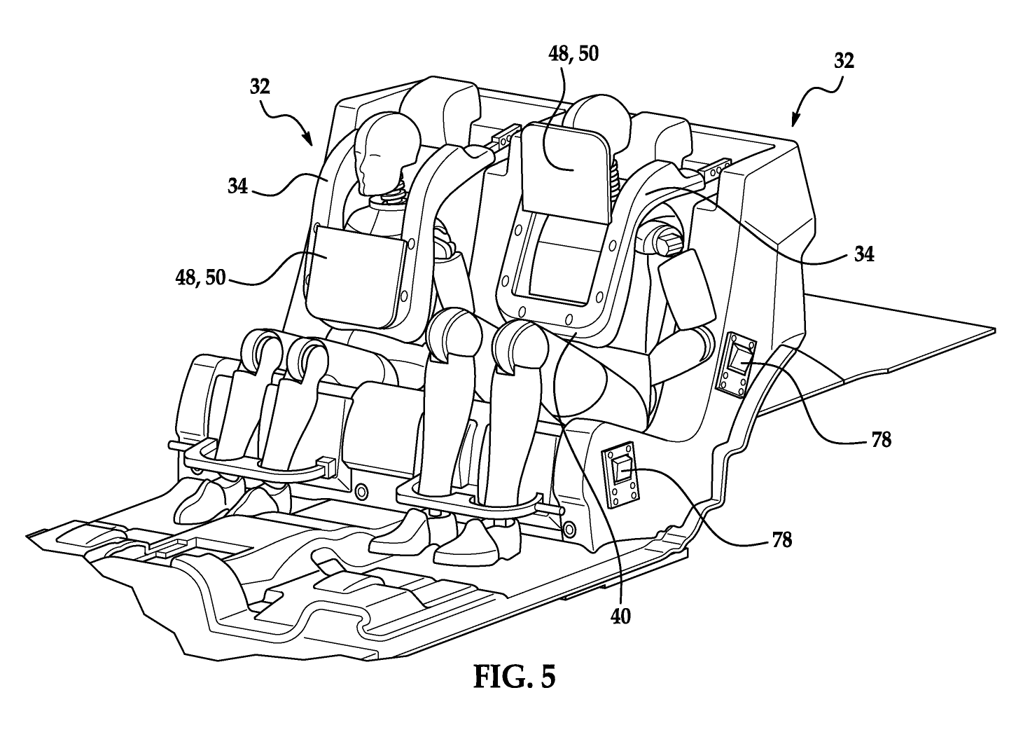

Movably mounted to the rigid member 34 is a spit guard frame 48 having a spit shield 50 coupled thereto. The spit guard frame 48 and the spit shield 50 are also movable between a stowed position and a deployed position, both illustrated in FIG. 5. The spit shield 50 may include a connecting member 52 (FIG. 4A) for attaching to the individual restrained within the torso restraint system 32, to retain the spit guard frame 48 and the spit shield 50 in the deployed position. In an embodiment, the connecting member 52 is a helmut-like and is positionable over a portion of the individual's head. The spit shield 50 may be formed from a material having a plurality of very small openings, for example mesh, to substantially block any fluids discharged from the individual without impeding a flow of air to the individual.

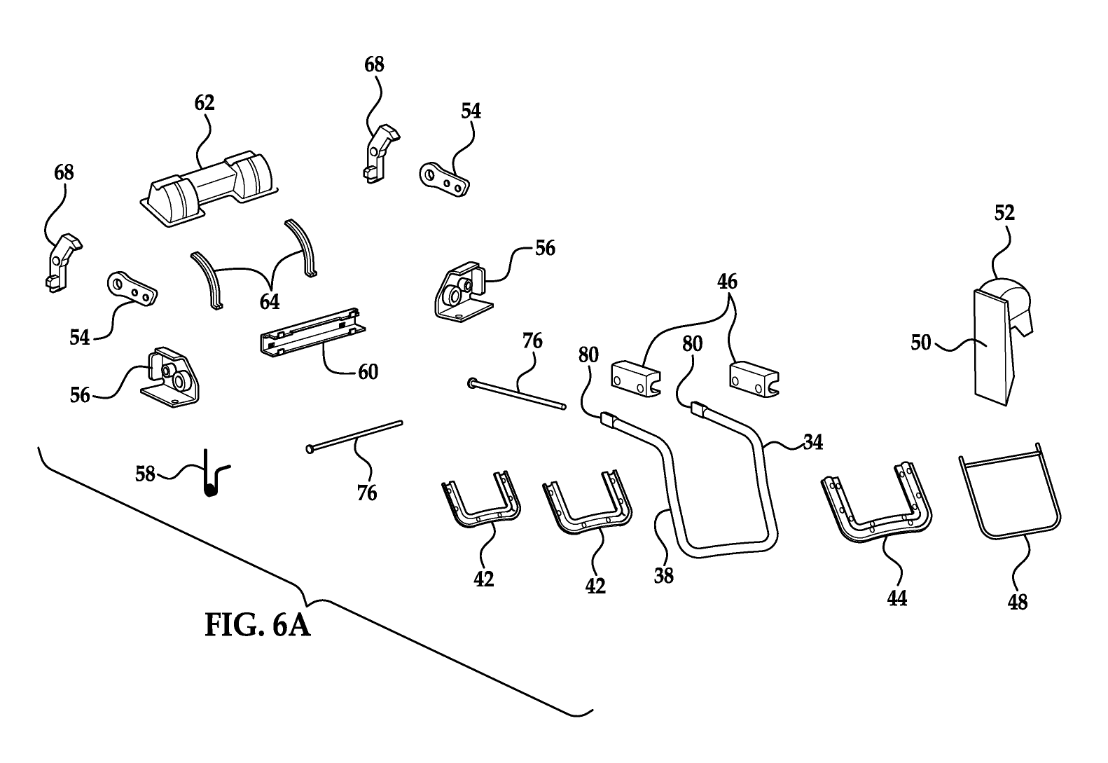

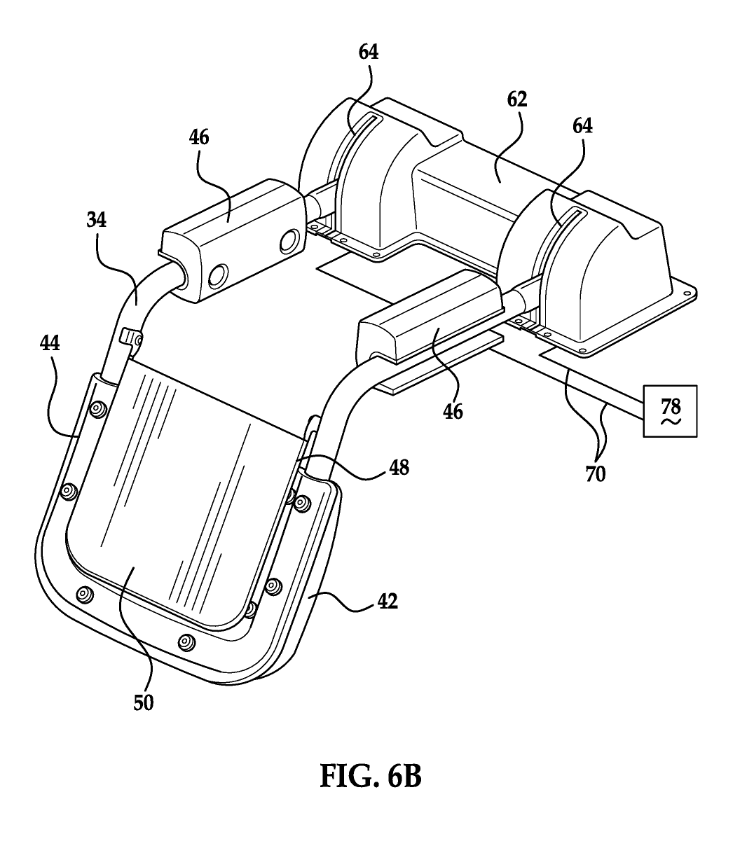

FIG. 6A is an exploded view of the torso restraint system 32 and FIG. 6B is an illustration of the assembled torso restraint system 32. Referring to FIGS. 6A and 6B, the torso restraint system 32 includes at least one locking plate 54, at least one pivot mounting bracket 56, at least one locking arm spring 58, an attachment bracket 60, a restraint housing 62, a gasket 64, at least one locking arm 68, at least one cable 70, mechanical fasteners 72, mechanical fasteners 74, at least one locking arm pivot pin 76, and a remote activation device 78. In one non-limiting embodiment, a pair of locking plates 54, a pair of pivot mounting brackets 56, a pair of locking arm springs 58, a pair of locking arms 68, a pair of cables 70 are provided for securement to each end 80 of the rigid member 34 to retain it in the stowed position and the deployed position as will be discussed herein.

In one embodiment, the locking plate 54 the locking arm spring 58, and the locking arm 68 cooperate to create portions of a locking mechanism for securing the rigid member 34 in the stowed position (FIG. 2) and the deployed position (FIG. 4). The locking mechanism is then coupled to a release mechanism 78 via a cable or cables 70 to release the same.

The rigid member 34 includes left and right handed attachment portions 80 that are each attached to a locking plate 54. It should be noted that while FIG. 6 illustrates both of the left and right handed attachment portions 80 each having a corresponding locking mechanisms, it is understood that in another embodiment the locking mechanism could be included on only one of the attachment portions 80 as well. It should also be noted that although two cables 70 are described herein, a single cable 70 may be used to release each of the locking mechanisms by moving a single item coupled to each of the locking mechanisms.

Still further, the aforementioned components are merely illustrative of one non-limiting locking mechanism and torso restraint system and other equivalent configurations are configured to be within the scope of exemplary embodiments of the present invention.

The torso restraint system 32 also includes a restraining housing 62 that includes an aesthetic covering. A gasket 64 attaches to the restraining housing 62 with integral fastening features (not shown). The housing 62 and gasket 64 is employed to conceal the locking mechanism of the torso restraint system 32 and can be affixed to a seat 20 (FIGS. 2-3) in a multitude of methods (snap-in, mechanical fasteners, etc.). Gasket 64 and housing 62 are configured to allow the rigid member 34 to move between the stowed position and the deployed position.

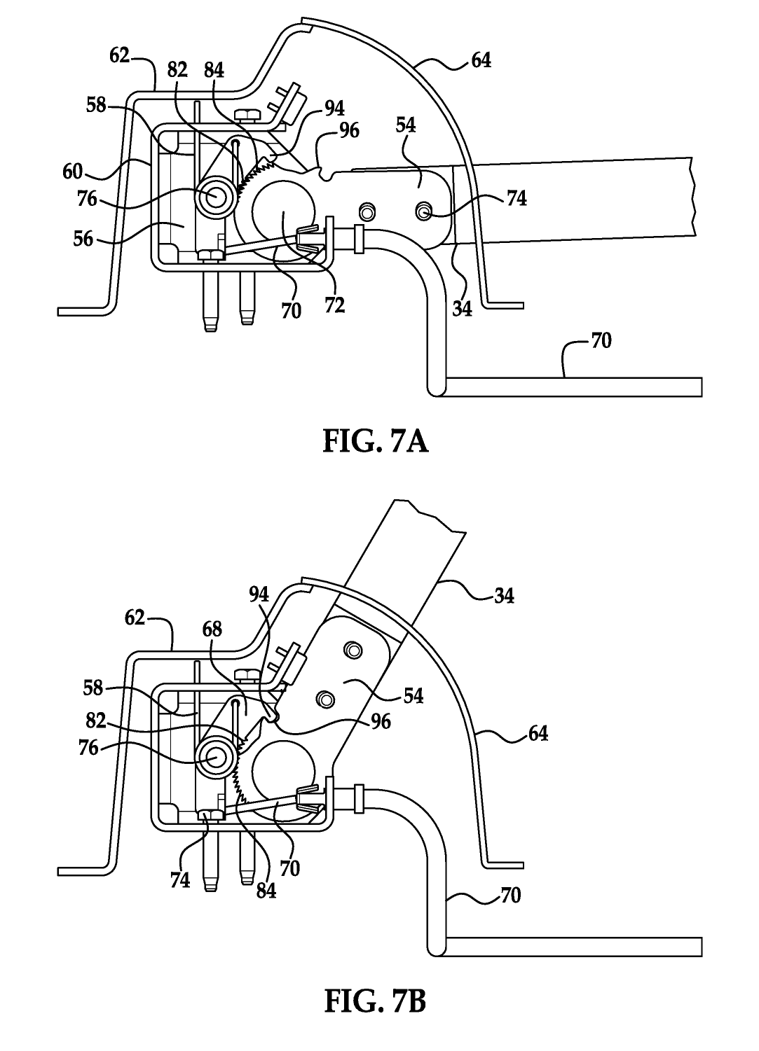

Referring now to both FIGS. 6A and 7A, during assembly of the torso restraint system 32 the left and right handed attachment portions 80 of the rigid member 34 are secured to a complimentary locking plate 54 that is pivotally secured to pivot mounting brackets 56 by a plurality mechanical fasteners 72, 74 such that the rigid member 34 can move or pivot between the stowed and deployed positions.

In one non-limiting embodiment, a pair of subassemblies each comprising an end portion 80 of the rigid member 34 and the locking plate 54 is pivotally attached to a corresponding pivot mounting bracket 56 via any suitable attachment means such as welding, which allows pivotal movement of the rigid member with respect to the mounting bracket 56 or any other equivalent member of the restraint system. Each of the pair of subassemblies is secured to the attachment bracket 60 with mechanical fasteners 72. Of course, other configurations are contemplated for example and in one alternative locking plate and pivot bracket may be integrally formed with the ends 80 of the rigid member 34.

A locking arm 68 is pivotally secured to each of the pivot mounting brackets 56 via a pivot pin 76. Each locking arm 68 is configured for movement between a locking position and a release position. The locking arm 68 is biased into the locking position by a biasing member such as a spring 58 that is secured to the attachment bracket 60 at one end and the locking arm 68 at the other end. When the locking arm 68 is in the locking position, a plurality of teeth or features 82 engage corresponding teeth or features 84 on the locking plate 54.

FIG. 7A is an illustration of the rigid member 34 in the deployed position wherein the locking arm 68 is illustrated in the locking position and the locking arm 68 has pivoted or rotated about the locking arm pivot pin 76 from the release position to the locking position. In this position, the locking arm 68 and the locking plate 54 selectively engage with one another through the plurality of teeth or features 82 that engage complimentary teeth or features 84 on the locking plate 54.

More specifically, and in one non-limiting embodiment, the locking arm 68 includes a first engagement feature 82, and the locking plate 54 includes a second engagement 84 feature. The first and second engagement features 82, 84 selectively engage with one another. In the illustrated embodiment, the first and second engagement features 82, 84 are angled mating teeth, however it is understood that other features that can selectively lock and unlock from one another may be used as well. Specifically, when the rigid member 34 is in the deployed position as shown in FIG. 7B, the first engagement feature 82 of the locking arm 68 interlocks with the second engagement feature 84 of the locking plate 54 and secures the rigid member 34 in the deployed position. Accordingly, the locking plate 54 and the locking arm 68 perform as a pawl and ratchet assembly.

When the rigid member 34 is actuated into the stowed position (shown in FIG. 7B), the first engagement feature 82 is disengaged from the second engagement feature 84. As mentioned above, each locking arm 68 is pivotable about the locking arm pivot pin 76 and is biased by a locking arm spring 58 into the locking position to act as a pawl that selectively engages with the restraint locking plate 54 as the plate 54 pivots with the rigid member 34 as it is moved into the deployed position.

In order to release the locking arm 68 from the locking position and allow the rigid member 34 to be moved back into the stowed position, a pair of cables 70 is secured to each locking arm 68 at one end and a release mechanism or remote activation device 78 at the other end. In one embodiment, both cables 70 are secured to a lever paddle 90 pivotally mounted to the release mechanism 78 such that as the lever paddle 90 is rotated, each cable 70 is retracted and the locking arm 68 is pivoted into the release position by over coming the biasing force of the locking arm spring 58 and thus the rigid member 34 can be moved into the stowed position. Once the lever paddle 90 is released, a spring 92 returns the lever paddle 90 to an un-actuated position and the cables 70 allow the locking arm 68 to rotate or pivot back into the locking position.

As illustrated in FIGS. 6A-6B, a third engagement feature 94 located adjacent an end of the locking arm 68 engages a detent 96 on the locking plate 54 to secure the rigid member 34 in place in the stowed position. The rigid member 34 is retained in a stowed position until a force sufficient enough to overcome the biasing force of the locking arm spring 58 is applied to pivot the locking arm 68 into a release position. Thus, the rigid member 34 remains in a stowed position until the cables 70 move, for example by actuation of the lever paddle 90. The weight of the rigid member 34 due to gravity may cause the rigid member 34 to tend to rotate to a deployed position once the locking arm 68 has been pivoted to a release position.

In one embodiment, the activation or positioning of the torso restraint system 32 into the deployed position (shown in FIG. 4) is manually operated by simply applying a downward force (e.g., toward the floor) to the rigid member 34 after the third engagement feature 94 has been decoupled from the detent 96. Once in the deployed position, locking arm 68 engages the locking plate 54 and the rigid member 34 is retained in the deployed position until the locking arm 68 is released via movement of cables 70.

Referring now to FIG. 7B, the disengagement of the locking arms 68 or the locking mechanism of an exemplary embodiment of the torso restraint system is accomplished via cables 70 that are, as mentioned above, secured to the locking arms 68 at one end and a remote activation device 78, which is located at a remote location. The remote activation device 78 is positioned such that the remote activation device 78 cannot be accessed by the individual (shown in FIG. 5) that is restrained in the torso restraint system 32. This is because the individual restrained in the torso restraint system 32 has a limited range of motion when the rigid member 34 is in the deployed position. Thus, the individual cannot generally move his upper torso or arms outside of area of the torso restraint system 32.

The remote activation device 78 is located in a remote location that is a predetermined distance D1 from the locking mechanism of the torso restraint system 32 such that the remote activation device 78 is outside of the range of motion. Thus, the individual restrained within the torso restraint system 32 is unable to grasp the activation device 78 when the rigid member 34 is in the deployed position. In embodiments where the torso restraint system is integrated into a vehicle 22, the activation device 78 may be located in a forward compartment of the vehicle 22, separate from the rearward compartment where the restraint device 32 and the restrained individual are located.

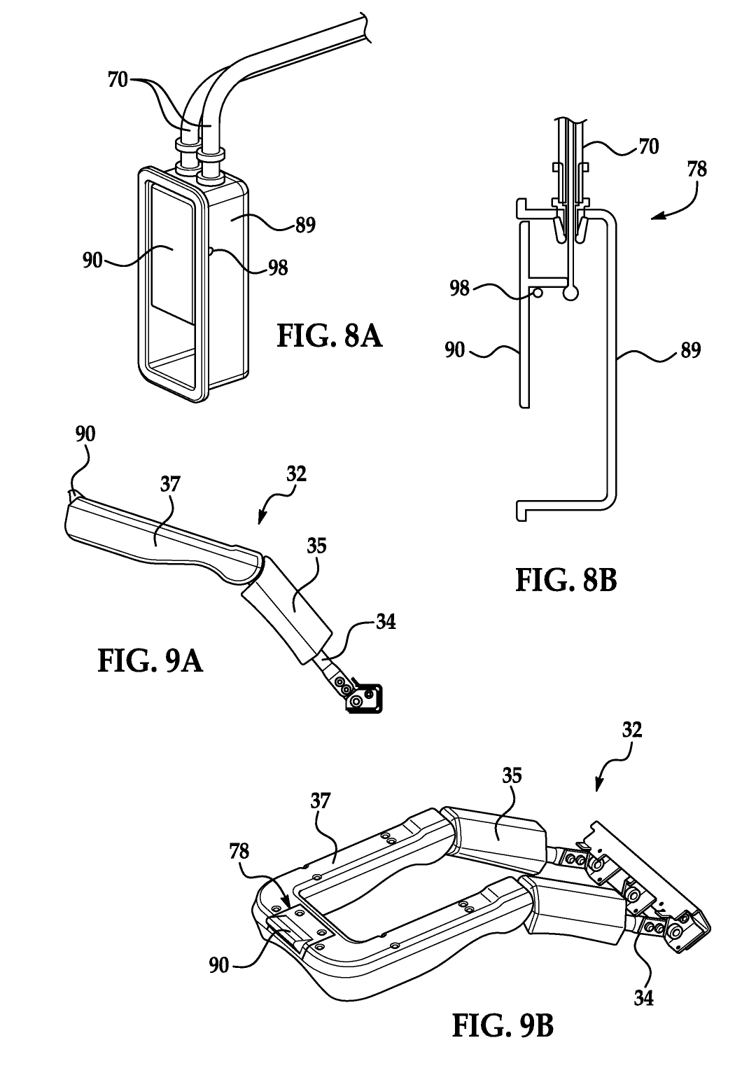

Referring now to FIGS. 8A and 8B, cables 70 pass through an opening located within in a housing 89 and are secured to lever paddle 90 pivotally secured to the housing 89 by a mechanical fastening system 98. In one embodiment, the mechanical fastening system 98 is a pivot pin and spring assembly such that the lever paddle 90 may be pivoted away from the housing 89 and pull the cables 70 such that locking arm 68 is rotated. Thereafter and upon release of the lever paddle 90, a spring 92 of the fastening system 98 will return the lever paddle 90 and the cables 70 back to the unreleased position and the locking arm 68 once again moves back to the locking position. Still further and in another alternative embodiment, the remote activation device 78 may be an electronic mechanism wired or wirelessly coupled to an electronic device such as a solenoid (not shown) that moves the locking member or arm 68 when a button of the release mechanism is activated.

In an embodiment of the torso restraint system, as shown in FIG. 6A, the rigid member 34 is formed from a single piece of material, bent to have a desired contour. In another embodiment of the torso restraint system 32, as shown in FIGS. 9A and 9B, the rigid member 34 includes two distinct portions: a shoulder portion 35 and a chest portion 37. When deployed, the shoulder portion 35 is configured to contact or restrict movement of an individual's shoulders and the chest portion 37 is configured to contact and restrict movement of the individual's chest. In an embodiment, the chest portion 37 is pivotally coupled to the shoulder portion 35 such that the chest portion 37 is movable between an extended position (shown) and a retracted position (not shown). In the retracted position, the chest portion 37 may be arranged generally perpendicular to the shoulder portion, or at an angle slightly greater than or slightly less than perpendicular. Inclusion of the additional joint between the shoulder and chest portion 35, 37 allows for further adjustment of the torso restraint system 32. As a result, the clearance between a person's chest and the U-shaped chest portion 37 of the rigid member 34, such as which may be present when the rigid member 34 is formed as a single piece, may be substantially reduced or eliminated. It should be understood that in some embodiments, the when the rigid member 34 is in the deployed position, movement of an occupant relative to the seat will be restricted regardless of whether the chest portion 37 is in an extended or retracted position. Inclusion of the additional joint in the rigid member 34 provides added flexibility that not only adapts the torso restraint system 32 to the body of the individual being restrained, but also allows the torso restraint system 32 to stow more easily in vehicles having awkward roof sweeps.

To control movement of the chest portion 37, a locking mechanism similar to the mechanism described with respect to FIGS. 5 and 6 may be located at the interface between the chest portion 37 and the shoulder portion 35. For example, a locking plate and a locking arm may cooperate to secure the chest portion 37 at a desired position. However, it should be understood that other suitable mechanisms that allow movement of the chest portion 37 from an extended position to a retracted position, but restrict movement of the chest portion 37 from a retracted position to an extended position are contemplated herein. In addition, the locking mechanism may additionally be coupled to an activation device, similar to activation device 78, to release the locking mechanism to allow movement of the chest portion back to the extended position. Further, once the locking mechanism is released, a biasing mechanism may be configured to bias the chest portion 37 from the retracted position to an extended position.

An activation device 78 associated with the locking mechanism at the interface of the chest portion 37 and the shoulder portion 35 may be integrated into rigid member 34. In the non-limiting embodiment of FIG. 9B, the handle or paddle 90 of the device 78 is positioned at the base of the U-shaped chest portion 37. By integrating the paddle 90 with the chest portion 37, the paddle 90 is outside of the range of motion of the occupant within the seat, but is easily accessible by other persons.

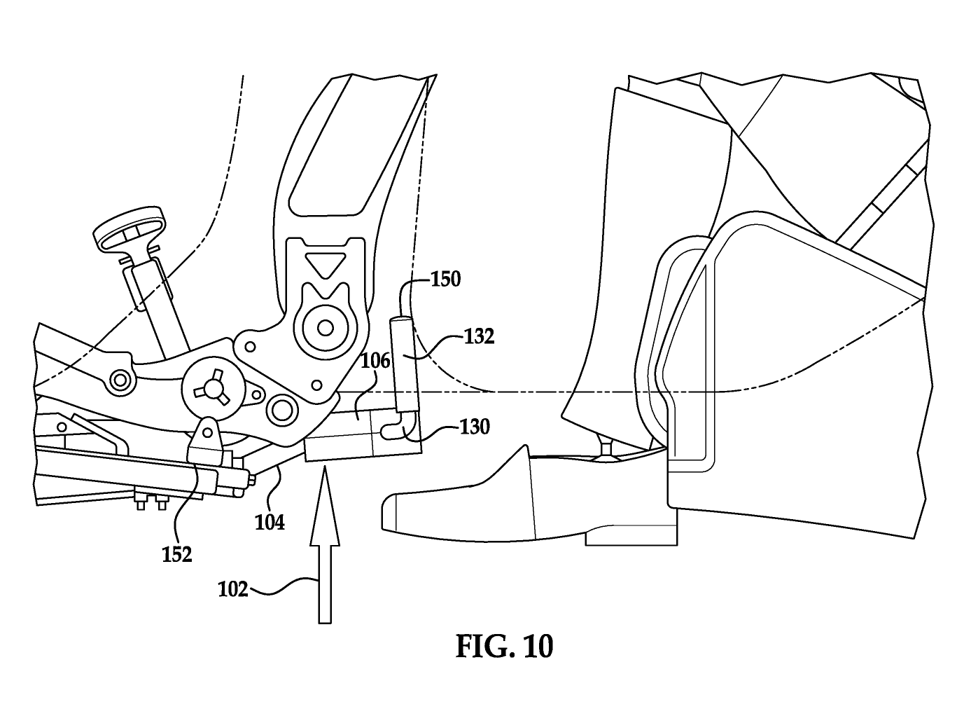

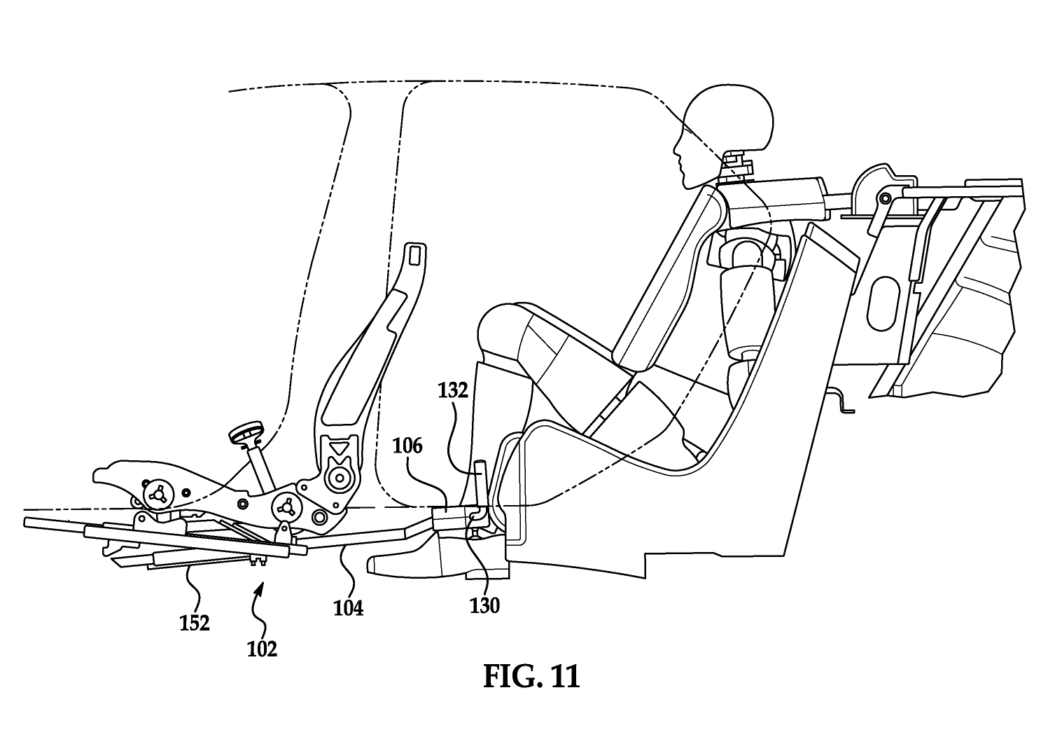

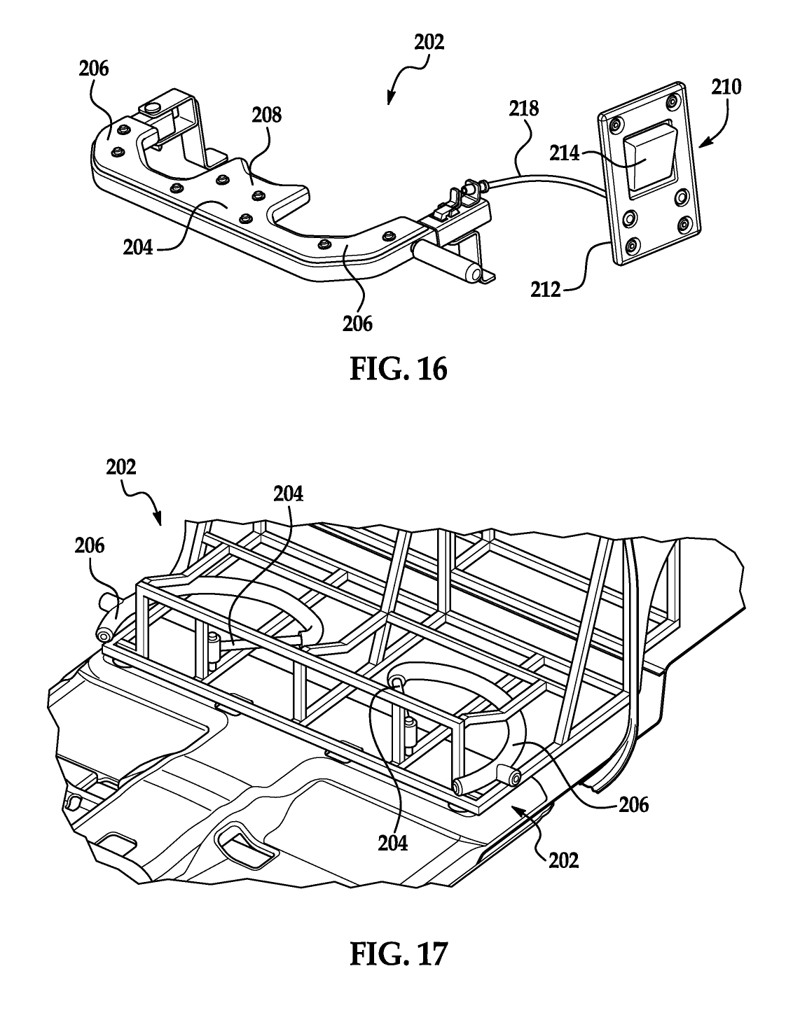

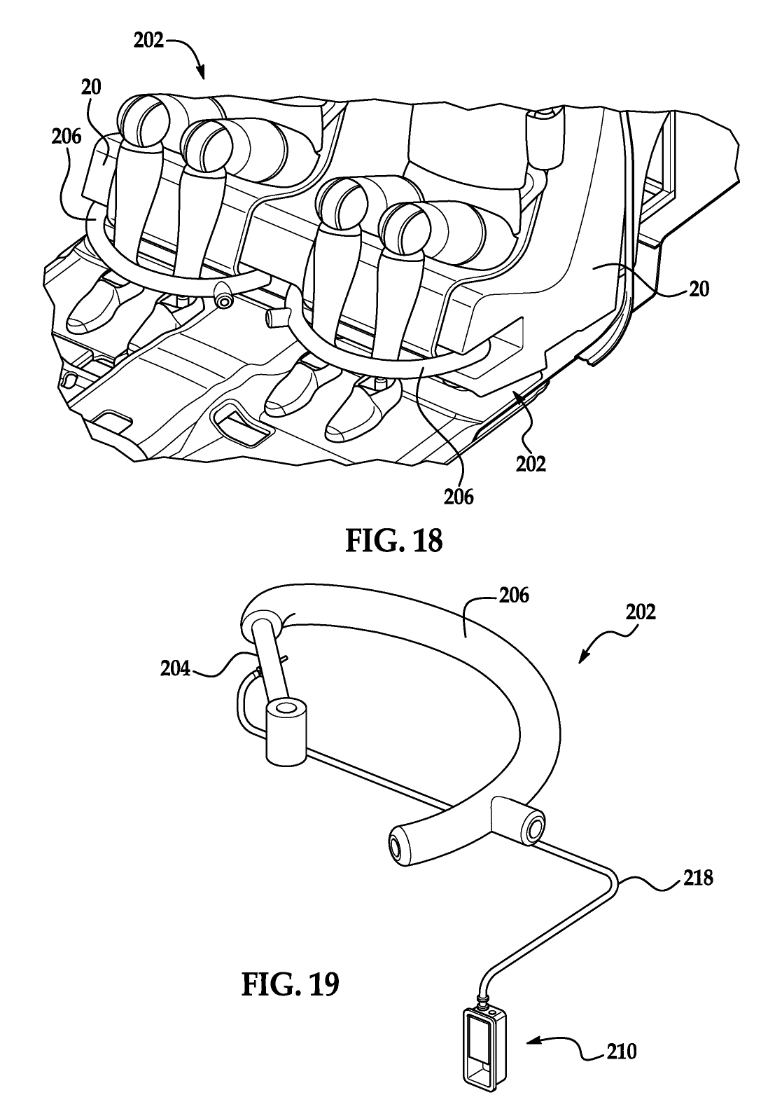

With reference now to FIGS. 10-20, the personal restraint system 30 may include a leg restraint system (“LRS”) 102 in addition to or in place of the torsional restrain system 32. The leg restraint system 102 is configured to selectively restrain the legs or a lower body portion of an occupant of the seat 20. In the non-limiting embodiment illustrated in FIGS., the leg restraint system 102 is adapted for use within a vehicle 22. FIG. 10 is an illustration of the leg restraint system 102 having a rigid member 104 in a stowed position, and FIG. 11 is an illustration of the rigid member 104 in an active or deployed position. In embodiments where the leg restraint system is used in a vehicle 22, the rigid member 104 is sized to fit within the interior cabin of the vehicle 22.

When the leg restraint system 102 is in the stowed position, as shown in FIG. 10, the rigid member 104 of the leg restraint system 102 does not generally restrain the lower body of the individual. As a result, the leg restraint system 102 does not interfere with the individual as he or she may enter and exits the seat 20. Turning now to FIG. 11, the rigid member 104 of the leg restraint system 102 generally restrains the lower body portion of the individual when in the deployed position. Thus, when in the deployed position, the leg restraint system 102 provides for enhanced securing of individuals in the seat 20 by restricting lower body motion of the individual. The individual is typically handcuffed or restrained such that the individual has a limited range of motion.

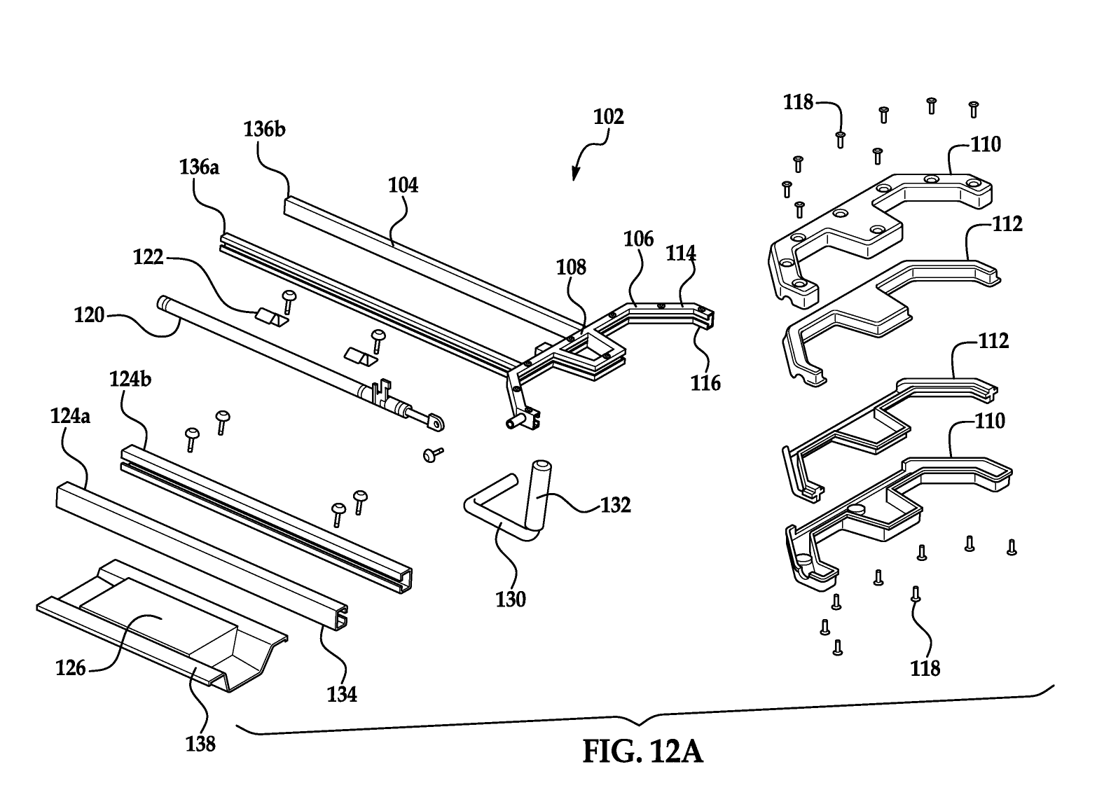

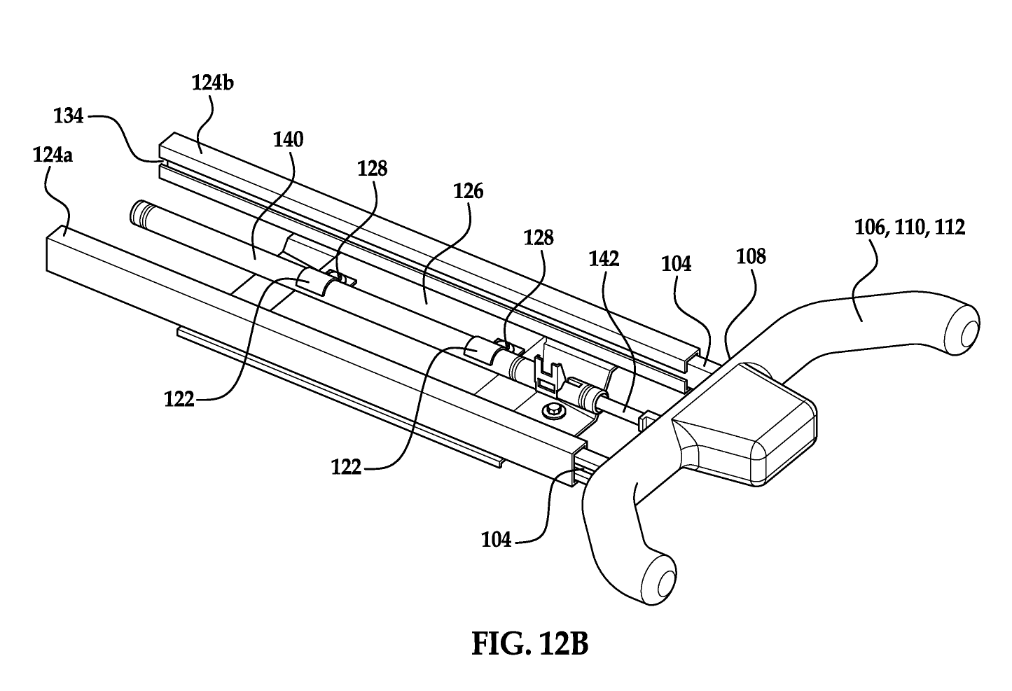

FIG. 12A is an exploded view of the leg restraint system 102 according to an embodiment and FIG. 12B is an illustration of the assembled leg restraint system 102. The rigid member 104 includes a curved or generally U-shaped portion 106 at one end 108 to surround a portion of the legs of an occupant within a seat 20. A pliable material 110 may be positioned around at least a portion of the U-shaped portion 106 to prevent injury to the legs of a vehicle occupant when the leg restraint system 102 is in a deployed position. In one embodiment, a retainer 112 and a pliable material 110 having a shape complementary to the retainer 112 are mounted to at least one of the upper surface 114 and the lower surface 116 of the U-shaped portion 106 with a plurality of fasteners 118.

In an embodiment, the leg restraint system 102 also includes a mech lock 120, at least one mech lock strap 122, at least one rail 124, a leg restraint mounting plate 126, mechanical fasteners 128, a leg restraint handle 130, and a leg restraint handle cover 132. During assembly of the leg restraint system 102, the rigid member 104 is slidably positioned within an opening 134 of the at least one rail 124. The rigid member 104 may include a plurality of legs 136, each of which may be received by a complementary rail 124. In the illustrated embodiment, the rigid member 104 includes a left leg 136a and a right leg 136b such that the left leg 136a is received within the opening 134 of a left rail 124a and the right leg 136b is received within the opening 134 of a right rail 124b. The left and right rails 124a, 124b are mounted to a surface 138 of the leg restraint mounting plate 126. In one embodiment, the rails 124a, 124b are welded to the leg restraint mounting plate 126. Alternatively, the rails 124a, 124b may be connected to the leg restraint mounting plate 126 with other known connection means, such as fasteners for example.

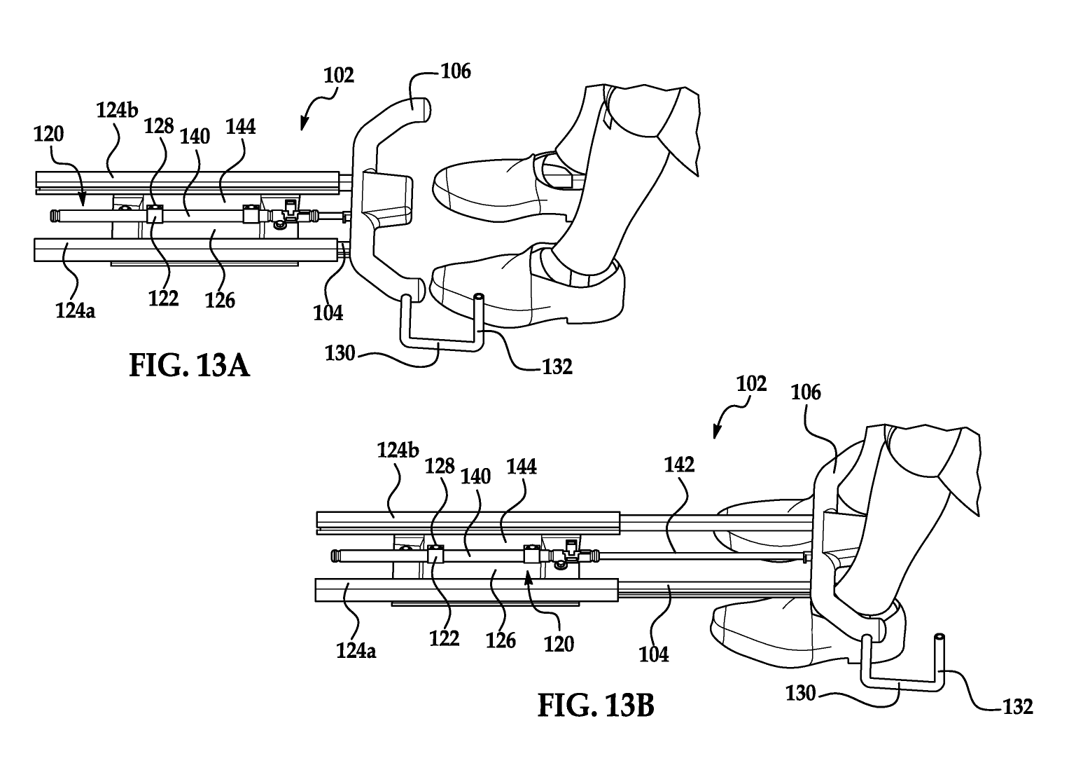

In one embodiment, the mech lock 120 includes an outer portion 140 and a telescoping inner rod 142 slidable relative to the outer portion 140 (best shown in FIGS. 13A and 13B). The mech lock 120 functions as a locking mechanism in a known manner by controlling the movement of the inner rod 142 relative to the outer portion 140. The outer portion 140 of the mech lock 120 is mounted to a portion of the leg restraint mounting plate 126 such as surface 144 for example, with the at least one mechanical lock strap 122 and a plurality of fasteners 128. The exposed end 146 of the inner rod 142 is connected to a portion of the rigid member 104, such as the generally U-shaped portion 106 for example. As the inner rod 142 of the mech lock 120 slides outward from the outer portion 140, the rigid member 104, coupled to the inner rod 142 slides relative to the rails 124 to a deployed position. When the leg restraining system 102 is returned to a stowed position, the inner rod 142 is received within the outer portion 140 of the mech lock 120. It should be understood that the mech lock 120 illustrated and described herein is intended as an example only, and other mechanism for controlling movement of the rigid member 104 between the stowed and deployed positions are also contemplated herein.

A leg restraint handle 130 is mounted to a portion of the rigid member 104, such as the generally U-shaped portion 106 for example. A portion of the leg restraint handle 130 may include a leg restraint handle cover 132 such that a person trying to operate the leg restraint system 102 may securely grasp the leg restraint handle 130. In one embodiment, the leg restraint handle 130 includes an actuator 150, such as a button for example, coupled to the mech lock 120. Alternatively, the actuator 150 may be located in a remote location outside of the range of motion of the occupant being restrained. A coupling mechanism (not shown), for example a cable, extends from the actuator 150 to a portion of the mech lock 120. In one embodiment, the actuator 150, and the coupling mechanism form a releasing mechanism for activating the locking mechanism and controlling movement of the inner rod 142 relative to the outer portion 140 of the mech lock 120.

In the illustrated, non-limiting embodiment of FIGS. 10-13, the leg restraint system is mounted to a component separate from the seat 20. As shown, the leg restraint mounting plate 126 is attached to the vehicle 22 at a mounting surface 152. As illustrated, the mounting surface 156 may be located underneath a driver's seat 158 or a passenger's seat (not shown), such as on the floor for example. It is understood that the leg restraint mounting plate 126 may be mounted to other surfaces as well.

To move the leg restraint system 102 from a stowed position to a deployed position, a person operates the actuator 150. When actuated, the outer portion 140 of the mech lock 120 releases the inner rod 142 so that the inner rod 142, and therefore the rigid member 104 coupled to the inner rod 142, may slide freely. The operator applies a force to the leg restraint handle 130 to move the rigid member 104 to a deployed position. When the actuator 150 is released, the outer portion 140 of the mech lock 120 will grip and hold the inner rod 142 in its current position. The rigid member 104 of the leg restraint system 102 is returned to a stowed position in a similar manner.

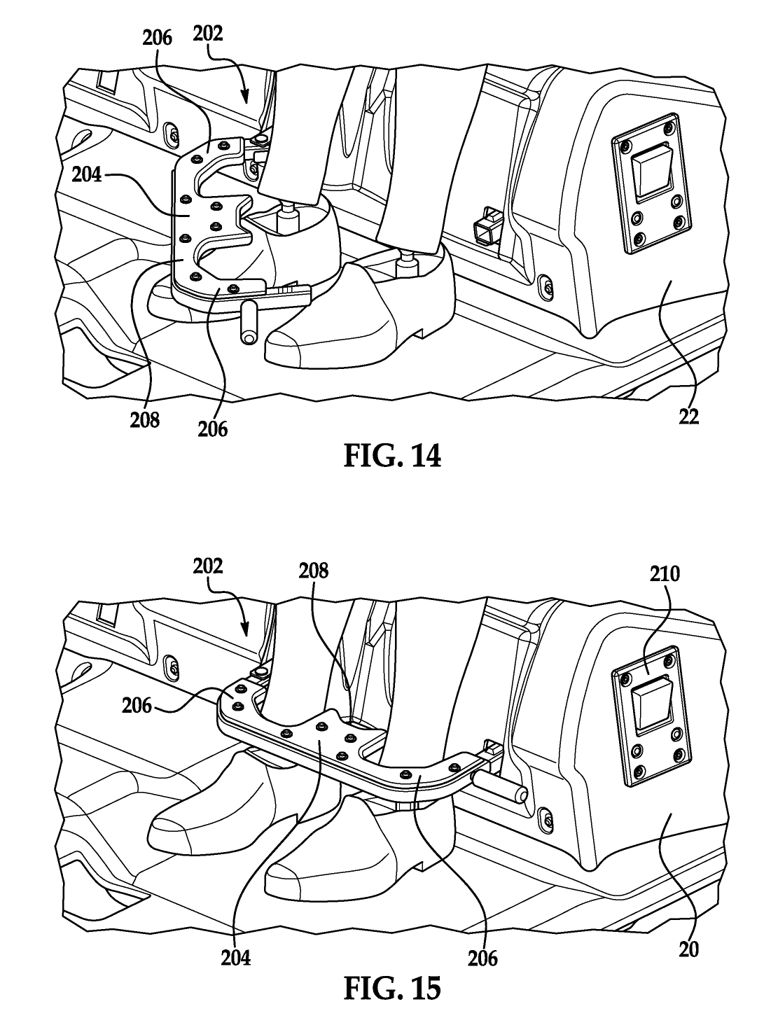

FIGS. 14-19 illustrate an alternate leg restraint system 202 according to an embodiment where the leg restraint system 202 is mounted directly to the seat 22. FIG. 14 represents the leg restraint system 202 in a stowed position relative to the seat 22 and FIG. 15 shows the leg restraint system 202 in a deployed position relative to the seat 22. The leg restraint system 202 includes a primary or rigid member 204 having a generally curved portion 206 for limiting the movement of a seated person's legs. In one embodiment, the curved portion 206 of the rigid member 204 is generally U-shaped with a central member 208 adapted to be positioned between an occupant's legs. In another embodiment of the leg restraint system 202, shown in FIGS. 17-19, the curved portion 206 of the rigid member 204 is generally semi-circular in shape.

As illustrated in the FIGS., the leg restraint system 202 is mounted directly to the seat 20 at a location near the area of an occupants legs when seated. The stowed position and the deployed position may be located within a plane, or alternatively, the deployed position may be perpendicular to the stowed position. In one embodiment, the leg restraint system 202 is mounted at least partially underneath the seat 20 such that the rigid member 204 rotates between about 30 degrees and about 180 degrees from a stowed position to a deployed position to retain the legs of the person occupying that seat 20. Alternatively, the leg restraint system 202 may be mounted adjacent a side 202 of the seat 200. In such embodiments, the rigid member 204 may pivot about 90 degrees or about 270 degrees from a stowed position to a deployed position. It is understood that the leg restraining system 202 may be mounted at alternate locations near a seat 22.

In one embodiment, the activation or positioning of any of the leg restraint systems 202 disclosed herein into the deployed position may be manually operated. Movement of the leg restraint system 202 from the deployed position to the stowed position may be accomplished automatically, such as in response to a remote activation device. The leg restraint system 202 may include a locking mechanism and/or a release mechanism as described with respect to the previous leg restraint system 102 or the torso restraint system 32.

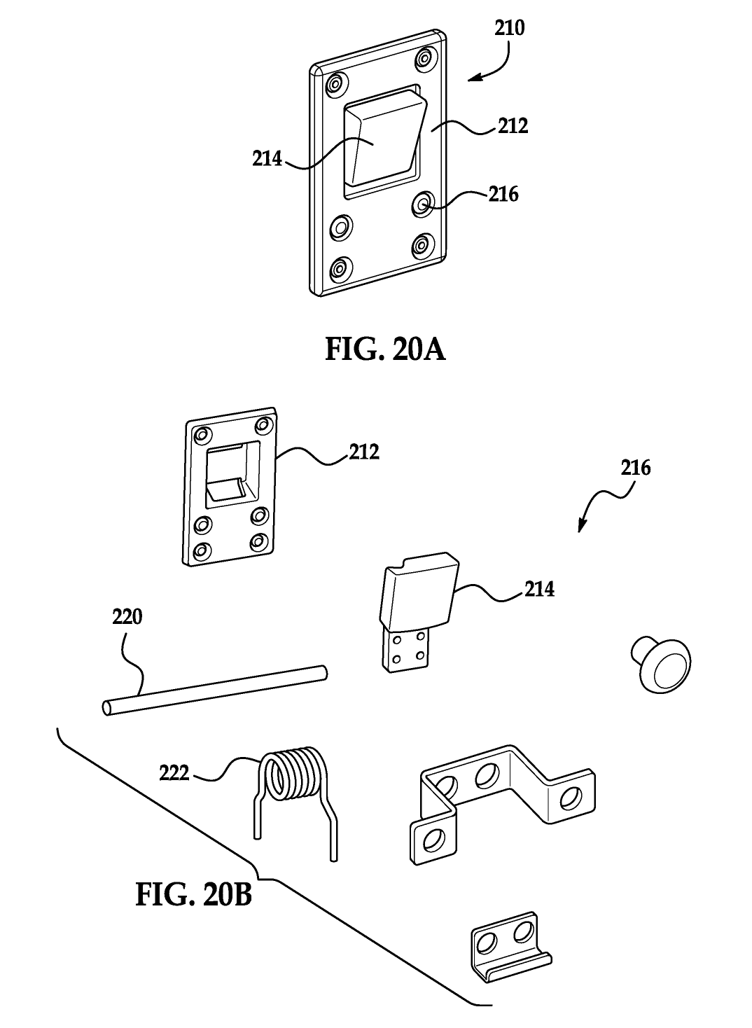

Referring now to FIGS. 20a and 20b, an example of a release mechanism 210 associated with the leg restraint system 202 includes a release mechanism housing 212 having a release handle pad 214 pivotally secured to the housing 212 by a mechanical fastening system 216. At least one cable 218 extending from the leg restraint system 202 may be coupled to a portion of the release handle pad 214. In an embodiment, the mechanical fastening system 216 includes a pivot pin 220 and a spring assembly 222 such that the release handle pad 214 may be pivoted to apply a force to the cables 218, thereby causing a locking component of the leg restraint system 202 to disengage. Upon removal of the force applied to the release handle pad, the at least one cable and the locking component return to the locking positions. In another embodiment, the release mechanism may be an electronic mechanism wired or wirelessly coupled to an electronic device such as a solenoid (not shown) that moves the locking component upon actuation of the release handle pad.

The remote activation device 210 is typically located at a position inaccessible to an occupant restrained within the seat 20. This is because the individual restrained in the leg restraint system 102 may be restrained, such as with handcuffs for example, and may have a limited range of motion when the rigid member 204 is in the deployed position. The release mechanism 210 is located in a remote location that is a predetermined distance from the leg restraint system 102 such that the release mechanism 210 is outside of the range of motion of the occupant being restrained. Thus, the individual restrained within the leg restraint system 102 is unable to grasp the activation device 210.

It should be understood that the release mechanism or activation device 210 illustrated and described herein may additionally be used with the torso restraint system, such as to control movement of the rigid member between a stowed position and a deployed position, and in embodiments where the rigid member includes a shoulder portion and a chest portion, to control movement of the chest portion between an extended and a retracted position.

The personal restraint system 30, and more specifically the torso restraint system 32 and the leg restraint system 102, 202 are described as being used in conjunction with a seat 20 to restrain an occupant within the seat 20.

In some embodiments, the personal restraint system 30 may be adapted for use with an existing seat structure, such as in a vehicle 22 for example. However, in other embodiments, the personal restraint system 30 may be assembled as a prepackaged module 300 including a seat 20 and at least one of torso restraint system 32 and the leg restraint system 102, 202 integrally formed with the seat 20. In such embodiments, the module 300 additionally includes at least one release mechanism 78, 210 integrally formed therewith.

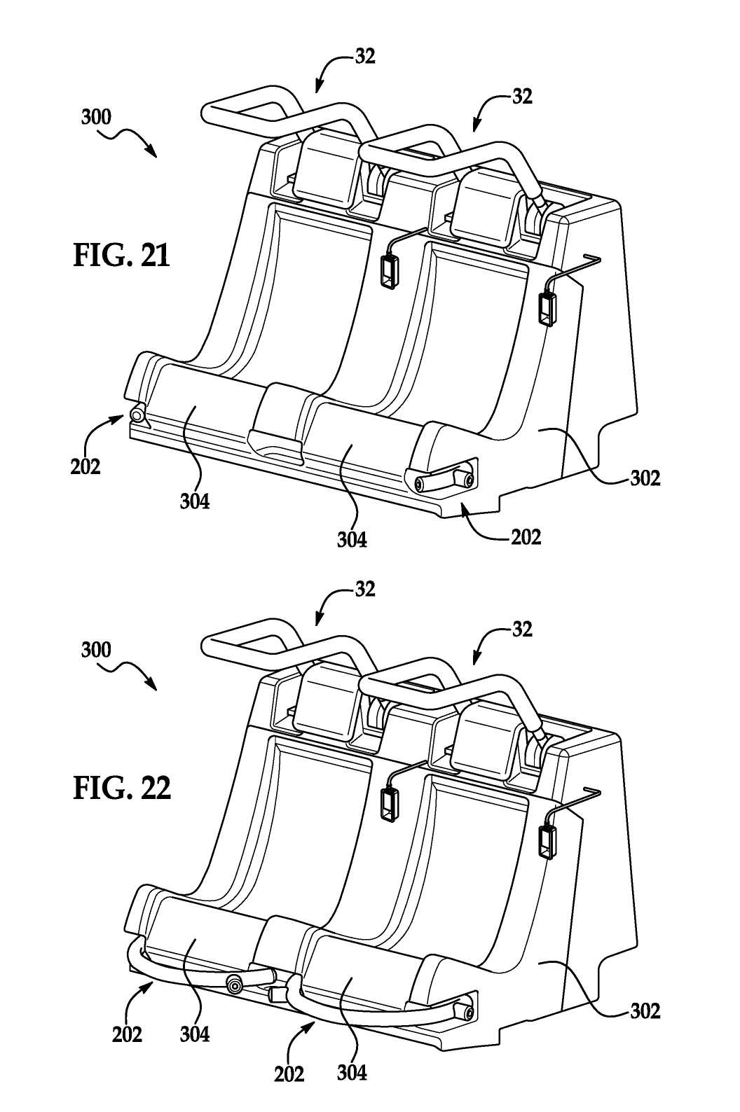

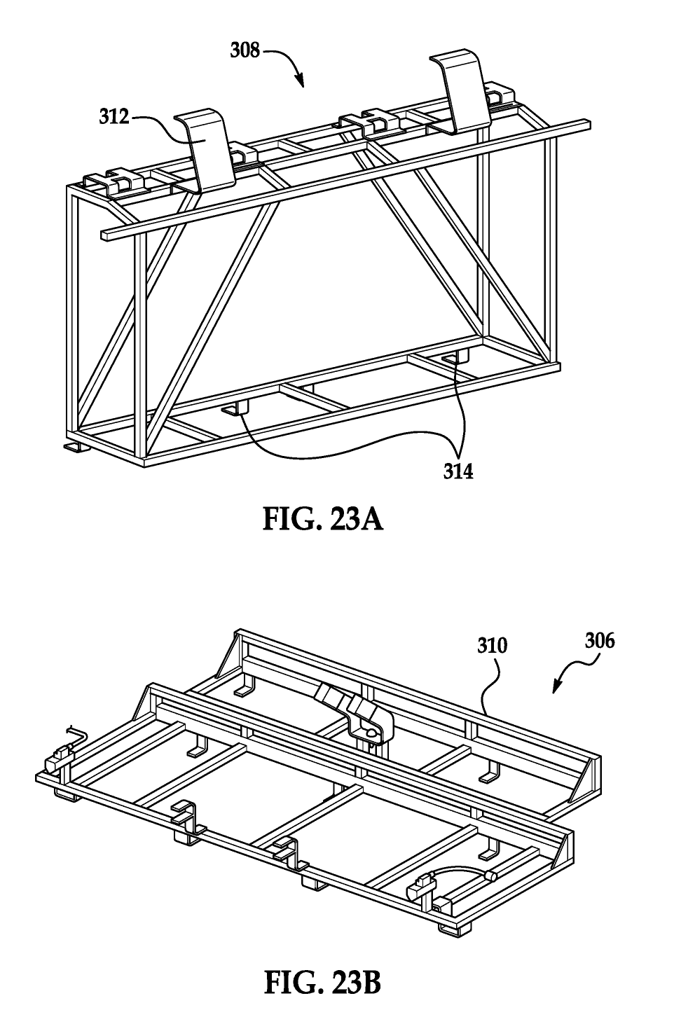

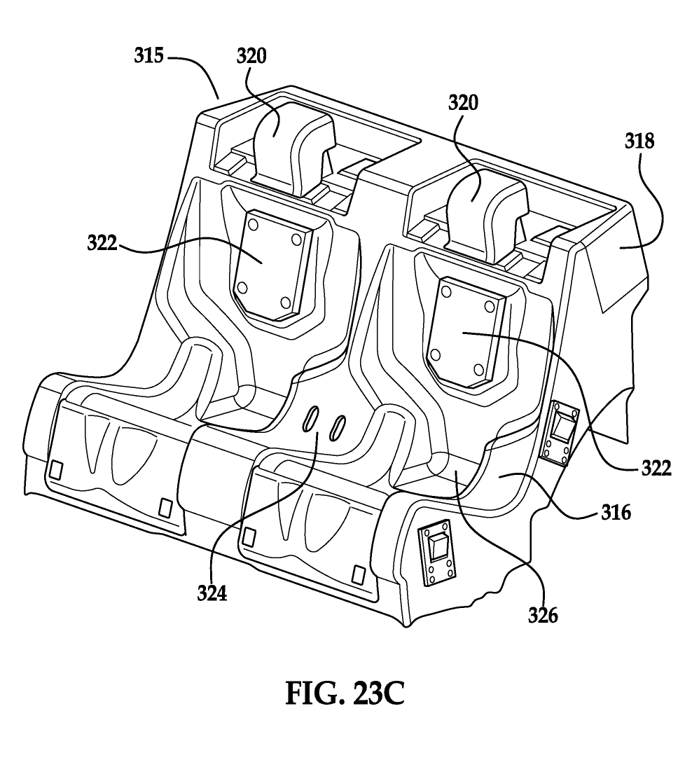

With reference now to FIGS. 21-23, an example of a personal restraint module 300 is illustrated in more detail. In the illustrated, non-limiting embodiment, the module 300 includes a seat structure 302 defining two seats 304 and a torso and leg restraint system 32, 102/202 associated with each seat 304. However, embodiments including a single seat 304 or more than two seats 304 are also contemplated herein. The seat structure 302 generally includes a base frame 306 and a main cage 308 configured to couple to the base frame 306. Mounting hardware (not shown) is configured to connect the main frame 308 to base frame 306 at a desired surface 310. As shown, the main cage 308 includes a head rest bracket 312 associated with each seat 304 of the seat structure 302 and additionally includes mounting brackets or other hardware 314 for connecting the main cage 308 to the floor.

In addition, one or more molded components 315 are receivable about the base frame 306 and the main cage 308 to define one or more distinct seats 304 of the module. A main seat 316 is generally positioned adjacent the main cage 308 and in overlapping arrangement with an upper surface of the base frame 306. A seat bench 318 may connect to the upper surface of the main cage 308, and specifically to the head rest brackets 312. The seat bench 318 may be adapted to receive a head rest pad 320 formed from a flexible, elastic, or otherwise pliable material, such as foam for example. In an embodiment, additional pads may be strategically positioned at desired portions of the seat bench, such as at a surface 322 that contacts an occupant's back for example. A portion of the moldable component 315 may additionally include opening 324 for receiving a retractable seat belt and/or a corresponding seat belt buckle for each seat 304. In addition a pocket or opening 326 for receiving an occupant's hands cuffed behind his back may be formed in each of seat. It should be understood that the seat structure 302 illustrated and described herein is intended as an example only, and that a seat structure 302 having another configuration compatible with at least one of the torso restraint system 32 and the leg restraint system 102/202 is contemplated herein.

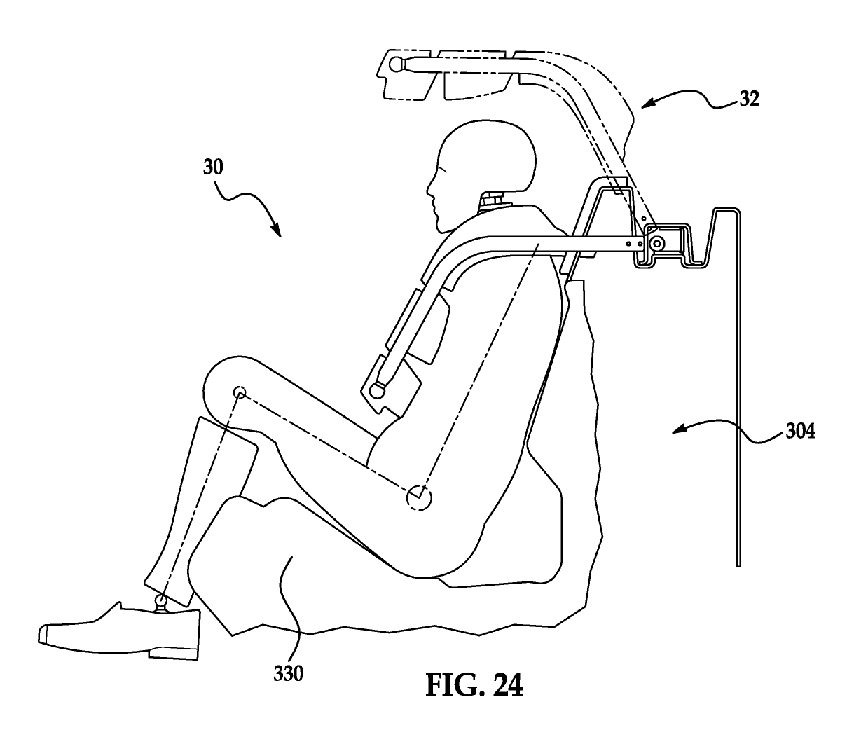

The contour of the molded seat 304 alone or in conjunction with the at least one of the torso restraint system 32 and the leg restraint system 102, 202 may be designed to place the seat occupant in a desired ergonomic position, best shown in FIG. 24. In the desired position, the occupant's ability to gain leverage while in the seat 20 is partially limited or even completely restricted. In an embodiment, the lower portion or base of the seat 304, indicated by 330 in the FIG., extends further forward and/or at a greater upward angle than a conventional seat. As a result, when an individual is seated within the seat 304, the contour of the seat prevents movement of the occupant's feet to a position generally underneath the seated center of mass, to provide the necessary leverage to begin to stand or get out of the seat. The motion limit provided by the torso restraint system 32 and the leg restraint system 102 may further restrict necessary movement of the occupant to get out of the seat 304. When a person is prevented from gaining leverage, the angle defined between a thigh and a calf of an occupant of the seat 20 is between about 70° and about 100°, between about 75° and about 95°, between about 80°-90° and about 84.6°. Further, an angle defined between the thigh and the chest of an occupant within the seat 20 is between about 70° and about 90°, between about 70° and about 90°, and more specifically about 80.2°.

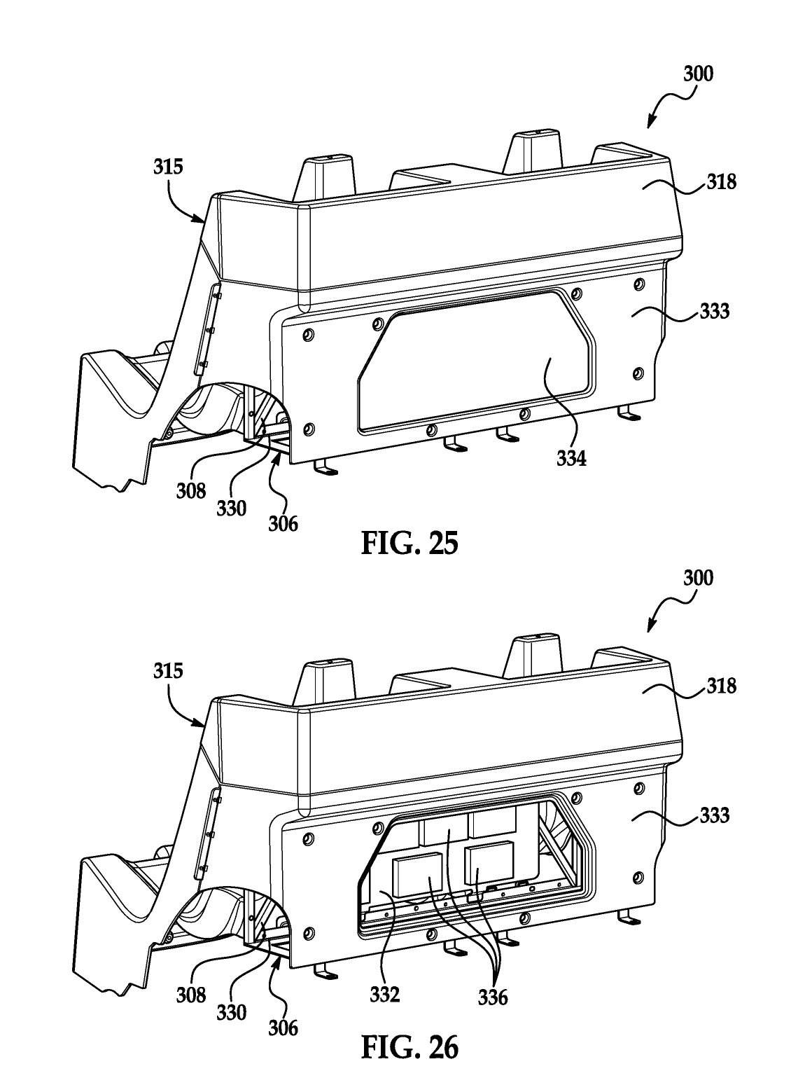

With reference now to FIGS. 25 and 26, a space or cavity 330 of the module 300 is defined by the base frame 306 and/or the main cage 308. In the illustrated, non-limiting embodiment, a vertical panel 332 is located within the space 330 and is coupled to a portion of the main cage 308. A removable access panel 334 may be formed in or coupled to the molded component 315, such as in a back side 333 of the module 300 for example, to easily provide a user with access to the cavity 330 and the panel 332.

The vertical panel 332 may include a plurality of openings (not shown) for receiving one or more storage modules 336. The storage modules 336 may be used to house components, such as electronic components for example, when the personal restraint module 300 is adapted for use in a vehicle 22. Although the storage modules 336 illustrated in the FIGS. are generally rectangular in shape, storage modules 336 having another configuration are also contemplated herein. Further, although the storage modules 336 are illustrated as being mounted to a first surface of the panel 332, embodiments where the modules 336 are mounted to opposing sides of the panel 332 are also within the scope of the disclosure. The vertical panel 332 is intended to receive a plurality of similar or different storage modules 336 in a variety of configurations. Through this modular configuration, the vertical panel 332 may be suitably adapted for use in multiple applications.

By forming the personal restraint system 30 as a modular unit 300, the module may be installed at any location where an individual may be detained, such as in a police station or a holding area for example. In addition, one or more personal restraint modules 300 may be adapted for use in a vehicle. In an embodiment, the personal restrain module 300 may be sized to replace all or a portion of the standard back seat of a vehicle 22. For example, the personal restraint module 300 may be adapted to replace the existing back seat of a sport utility vehicle where the back seat is open to the truck, and no structure is located adjacent the back seat for supporting the locking mechanism of the torso restraint system.

The systems of FIGS. 21-26 significantly improve occupant restraint. The system enables law enforcement or military personal the option to deploy an enhanced restraint system to immobilize the individual thus resulting in a safer environment for transporting the individual. Current vehicles do not provide an option for enhanced restrain and therefore individuals have excessive body movement thus creating an undesirable environment for the individual, the law enforcement personal, and others nearby. This system can be packaged in any passenger vehicle environment.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A restraint system for restraining a lower body portion of an individual within a seat comprising:
a rigid member configured to selectively restrain the lower body portion such that the lower body portion of the individual is movable only within a predefined area of movement, the rigid member being mounted to the seat and being capable of movement between a stowed position and a deployed position, the lower body portion being restrained by the rigid member only in the deployed position;
a locking mechanism for locking the rigid member in the stowed position and the deployed position; and
a release mechanism associated with the locking mechanism, the release mechanism being located at a predetermined distance from the locking mechanism such that the release mechanism is located outside of the area of movement.

2. The restraint system of claim 1, wherein the restraint system includes a mounting bracket for attaching to a mounting surface near the area of movement of the individual.

3. The restraint system of claim 2, wherein the mounting surface is associated with a seat disposed within a vehicle.

4. The restraint system of claim 3, wherein the seat of the vehicle includes a cavity for receiving the restraint system such that when the rigid member is in the stowed position the restraint system is located substantially within the cavity.

5. The restraint system of claim 4, wherein the cavity is located underneath the seat.

6. The restraint system according to claim 3, wherein the mounting surface is positioned in front of the lower body portion of the individual.

7. The restraint system of claim 1, wherein the stowed position and the deployed position are coplanar.

8. The restraint system of claim 1, wherein the rigid member includes a “U” shaped portion configured to surround a portion of a pair of legs of the individual.

9. The restraint system of claim 1, wherein the release mechanism includes a cable system and a housing with a spring biased release paddle, wherein the cable system includes at least one cable that is secured to the spring biased release paddle at one end and the locking mechanism at the other end.

10. The restraint system of claim 9, wherein the locking mechanism includes a mech lock having a movable inner rod coupled to the rigid member.

11. The restraint system of claim 1, wherein the locking mechanism includes a mech lock for maintaining the rigid member in the deployed position.

12. The restraint system of claim 11, wherein the release mechanism includes an actuator and a coupling mechanism secured at a first end to the actuator and at a second end to the mech lock.

13. The restraint system of claim 12, wherein the actuator is located within a handle connected to the rigid member.

14. The restraint system of claim 12, wherein the coupling mechanism is a cable.

15. The restraint system according to claim 11, wherein the mech lock includes an inner slide and an outer rod, the inner rod being selectively coupled to the outer rod, wherein the release mechanism decouples the inner rod from the outer rod to allow movement of the rigid member.

16. The restraint system of claim 9, further comprising:
a second rigid member for selectively restraining an upper body portion such that the upper body portion of the individual is movable only within a second predefined area of movement, the second rigid member being movable between a stowed position and a deployed position, the upper body portion being restrained by the second rigid member only in the deployed position;
a second locking mechanism for locking the second rigid member in the deployed position; and
a second release mechanism associated with the second locking mechanism, the second release mechanism being located at a predetermined distance from the second locking mechanism such that the second release mechanism is located outside of a second area of movement within the range of movement.

17. The restraint system of claim 16, wherein a spit shield assembly is associated with the second rigid member, the spit shield assembly being movable between a stowed position and a deployed position, wherein in the deployed position, the spit shield assembly substantially blocks a fluid discharged from the individual.

18. A personal restraint module comprising:
a seat structure defining at least one seat; and
a first restraint system integrated with the seat structure adjacent the at least one seat to selectively restrain a body portion of an individual seated within the at least one seat, the first restraint system being movable between a stowed position and a deployed position, wherein the body portion is only restrained when the first restraint system is in the deployed position.

19. The personal restraint module according to claim 18, wherein the first restraint system is locked in the deployed position.

20. The personal restraint module according to claim 19, wherein a first release mechanism is associated with the first restraint system, the first release mechanism being operable to release the first restraint system from the deployed position.

21. The personal restraint module according to claim 20, wherein the first release mechanism is integrated into a portion of the seat structure.

22. The personal restraint module according to claim 18, further comprising:
a second restraint system integrated with the seat structure adjacent the at least one seat to selectively restrain another body portion of the individual, the second restraint system being movable between a stowed position and a deployed position, wherein the another body portion is only restrained when the second restraint system is in the deployed position.

23. The personal restraint module according to claim 22, wherein the second restraint system is locked in the deployed position.

24. The personal restraint module according to claim 23, wherein a second release mechanism is associated with the second restraint system, the second release mechanism being operable to release the second restraint system from the deployed position.

25. The personal restraint module according to claim 22, wherein at least one of the first restraint system and the second restraint system is configured to restrain an upper body portion of the individual and the other of the first restraint system and the second restraint system is configured to restrain the lower body portion of the individual.

26. The personal restraint module according to claim 18, wherein the seat structure includes at least one molded component positioned adjacent to a support structure.

27. The personal restraint module according to claim 26, wherein the support structure includes a base frame and a main cage.

28. The personal restraint module according to claim 18, wherein the personal restraint module is adapted for use in a building.

29. The personal restraint module according to claim 18, wherein the personal restraint module is adapted for use in a vehicle.

30. The personal restraint module according to claim 29, wherein the personal restraint module is configured as at least a portion of a back seat of a vehicle.

31. The personal restraint module according to claim 18, wherein the seat structure defines a cavity within which one or more components may be located.

32. The personal restraint module according to claim 31, wherein a removable access panel selectively provides a user access to the cavity.

33. The personal restraint module according to claim 31, further comprising a panel adapted for receiving one or more storage modules positioned within the cavity.

34. A personal restraint module for restraining an individual comprising:
a seat structure defining at least one seat;
a restraint system integrated with the seat structure adjacent the at least one seat to selectively restrain a body portion of an individual, wherein a contour of the seat structure prevents the individual from gaining leverage while seated.

35. The personal restrain module according to claim 34, wherein the individual has a seated center of mass and the contour of the seat structure restricts the individual from positioning a foot generally underneath the seated center of mass.

36. The personal restraint module according to claim 34, wherein once the individual is seated within the seat structure, the contour of the seat structure restricts the individual from standing to get out of the seat.
